(19) United States
(12) Patent Application Publication
(10) Pub. No.: US 2010/0043698 A1
(43) Pub. Date: Feb. 25, 2010

(54) REPLACEABLE BUILD BOX FOR THREE DIMENSIONAL PRINTER

(75) Inventor: Joseph Bolt, Irwin, PA (US)

Correspondence Address: BLYNN L. SHIDELER;THE BLK LAW GROUP, 3500 BROKKTREE ROAD, SUITE 200, WEXFORD, PA, 15090, US

(73) Assignee: The Ex One Company,LLC, Irwin, PA (US)

(21) Appl. No.: 12/546,400

(22) Filed: Aug. 24, 2009

Related U.S. Application Data
(63) Continuation of application No. PCT/US08/54884, filed on Feb. 25, 2008.
(60) Provisional application No. 60/891,352, filed on Feb. 23, 2007.
(60) Provisional application No. 60/891,336, filed on Feb. 23, 2007.

(51) Int. Cl. B05C 11/02; B05C 13/02

(52) U.S. Cl. 118/46; 118/500

(57) ABSTRACT

A removable build box for a three dimensional printer comprises a build box tray defining a build chamber for part assembly and a material feed chamber for supplying powder material to the build chamber. The build and feed chambers have lower piston stops. A build chamber piston engages with the build chamber and with the build chamber piston stops at a lowermost position. A feed chamber piston engages with the feed chamber and with the feed chamber piston stops at a lowermost position. A quick connection coupling is between the build chamber piston and a build chamber z-axis actuator configured to move the build chamber piston when connected thereto. A quick connection coupling is between the feed chamber piston and a feed chamber z-axis actuator configured to move the feed chamber piston when connected thereto. The build box tray may be easily removed from the three dimensional printer.

### RELATED APPLICATIONS

This application is a continuation of international application PCT/US08/548884 entitled “Replaceable Build Box for a Three Dimensional Printer” filed Feb. 25, 2008. International application PCT/US08/548884 claims the benefit of provisional patent application 60/891,352 entitled “Rapid Build Box for a Three Dimensional Printer” filed Feb. 23, 2007. International application PCT/US08/548884 claims the benefit of provisional patent application 60/891,336 entitled “Rapid Build Box for a Three Dimensional Printer” filed Feb. 23, 2007.

### BACKGROUND OF THE INVENTION

1. Field of the Invention

The present invention relates to a three dimensional printer, in particular to a replaceable build box for a three dimensional printer.

2. Background Information

Three-dimensional printing (3D printing) is a subdivision of the rapid prototyping technology that was, in part, developed at the Massachusetts Institute of Technology (MIT) for the rapid and flexible production of prototype parts, end-use parts, and tools directly from a CAD model. Three Dimensional Printing, or 3D Printing, has unprecedented flexibility. It can create parts of any geometry, and out of any material, including ceramics, metals, polymers and composites. Furthermore, it can exercise local control over the material composition, microstructure, and surface texture. 3D printers are generally faster, more affordable and easier to use than other rapid prototyping technologies. This technology is marketed commercially by ExOne Company.

Three Dimensional Printing functions by building parts in layers. From a computer (CAD) model of the desired part, a slicing algorithm draws detailed information for every layer. Each layer begins with a thin distribution of powder spread over the surface of a powder bed, such as gold powder for dental copings. Using a technology analogous to ink-jet printing, a binder material selectively joins particles where the object is to be formed. A piston that supports the powder bed and the part-in-progress within a build box lowers so that the next powder layer can be spread and selectively joined. This layer-by-layer process repeats until the part is completed within the build box. Following a heat treatment, unbound powder is removed, leaving the (semi) fabricated part, also called a green part within this application. The sequence of operations is schematically depicted in FIG. 1.

The Three Dimensional Printing process combines powders and binders with unprecedented geometric flexibility. The support gained from the powder bed means that overhangs, undercuts and internal volumes can be created (as long as there is a hole for the loose powder to escape). Three Dimensional Printing can form any material that can be obtained as a powder. This includes just about any material. Further, because different materials can be dispensed by different print heads, 3D Printing can exercise control over local material composition. Material can be in a liquid carrier, or it can be applied as molten matter. The proper placement of droplets can be used to create surfaces of controlled texture and to control the internal microstructure of the printed part.

The Three Dimensional Printing process surpasses conventional powder processing because while the Three Dimensional Printing components rival the performance of those made by conventional methods, there are no tooling or geometric limitations with Three Dimensional Printing. Because of its great flexibility in handling a wide range of materials and because of the unique ability to locally tailor the material composition, Three Dimensional Printing offers potential for the direct manufacture of structural components with unique microstructures and capabilities. Three Dimensional Printing is also readily scaled in production rate through the use of multiple nozzle technology which has been commercially developed for printing images on paper.

The 3D-Printing rapid prototyping process is described in more detail in U.S. patents Sachs et al U.S. Pat. No. 5,204,055 (issued Apr. 20, 1993), Cima et al. U.S. Pat. No. 5,387,380 (issued Feb. 7, 1995), and Sachs U.S. Pat. No. 6,036,777 (issued Mar. 14, 2000) which are herein incorporated by reference. See also U.S. Pat. Nos. 5,340,656 and 5,387,380 which are herein incorporated by reference.

Depending on the intended use of the article, the three dimensional printed article is generally a porous or low density structure and it may thereafter be infiltrated with a suitable infiltrant, such as a polymer, or a metal having a liquidus temperature lower than that of the three dimensional printed article which can be moved into. The porous article that is infiltrated with another material, such as a lower melting temperature metal, will give a fully dense article with desirable properties.

The ExOne Company has utilized the three dimensional printing process for the rapid formation of dental copings. Dental copings are structures, typically metal such as gold, which fit onto the patients prepared tooth that can form the basis for a bridge or similar dental structure. It is not uncommon for the material to be changed for different runs of products. For example for dental components different users may elect a different material. The switching out of the material is a labor intensive operation as the build box needs to be thoroughly cleaned.

In addition to the labor costs and lost production time, there is a material loss associated with the residue that is removed during material change outs. With certain materials, such as gold powder, the residue loss is so critical that the cloths that are used to wipe down the build box are consumed in a process that attempts to recover the residue. This recovery step can be economical and can reduce the residue product loss, but it represents an additional cost to the system operation as well.

In addition to the costs described above there is a security issue in locations that are not operational on a continuous basis. Currently the entire three dimensional printer must be housed in a secure location to protect the valuable material that may be remaining within the build box (e.g. several grams of gold powder)

There is a need to address the deficiencies of the prior art three dimensional printers.

### SUMMARY OF THE INVENTION

One embodiment of the present invention provides a removable build box for a three dimensional printer comprising a build box tray defining a build chamber for part assembly, the with the build chamber having lower piston stops, a build chamber piston slidably engaged with the build chamber and selectively engagable with the piston stops of the build chamber at a lowermost position of the piston; and a quick connection coupling between the build chamber piston and a build chamber z-axis actuator configured to move the build chamber piston when connected thereto, whereby the build box tray may be easily removed from the three dimensional printer.

One embodiment of the present invention provides a removable build box for a three dimensional printer comprising a build box tray defining a material feed chamber for supplying powder material to a build chamber, the feed chamber having lower piston stops, a feed chamber piston slidably engaged with the feed chamber and selectively engagable with the piston stops of the feed chamber at a lowermost position of the piston; and a quick connection coupling between the feed chamber piston and a feed chamber z-axis actuator configured to move the feed chamber piston when connected thereto, whereby the build box tray may be easily removed from the three dimensional printer.

One embodiment of the present invention provides a removable build box for a three dimensional printer comprising a build box tray defining a build chamber for part assembly and a material feed chamber for supplying powder material to the build chamber, the build chamber having lower piston stops and the feed chamber having lower piston stops, a build chamber piston slidably engaged with the build chamber and selectively engagable with the piston stops of the build chamber at a lowermost position of the build chamber piston, a feed chamber piston slidably engaged with the feed chamber and selectively engagable with the piston stops of the feed chamber at a lowermost position of the feed chamber piston, a quick connection coupling between the build chamber piston and a build chamber z-axis actuator configured to move the build chamber piston when connected thereto, and a quick connection coupling between the feed chamber piston and a feed chamber z-axis actuator configured to move the feed chamber piston when connected thereto, whereby the build box tray may be easily removed from the three dimensional printer.

One embodiment of the present invention provides a rapid build box feed chamber filling and storage unit for supplying material to and storing material from a feed chamber of a build box of a three dimensional printer. The unit includes a feed box member defining a storage chamber having an open top and open bottom, the feed box member including alignment members for aligning the storage chamber vertically above the feed chamber. The unit includes at least one piston engaging latch coupled to the feed box and configured to selectively extend within the storage chamber to selectively engage a feed chamber piston that is receivable within the storage chamber. The unit includes an actuator coupled to each latch for moving the latch between the piston engaging and non-engaging positions, and a lid removeably coupled to the feed box and configured to selectively cover the top opening of the storage chamber.

These and other advantages of the present invention will be clarified in the brief description of the preferred embodiment taken together with the drawings in which like reference numerals represent like elements throughout.

### BRIEF DESCRIPTION OF THE DRAWINGS

FIG. 1 is a schematic view of a conventional 3D printing process;

FIG. 2 is a perspective view of a three dimensional printer with a removable build box according to one aspect of the present invention;

FIG. 3 is a perspective view of the removable build box of FIG. 2 according to one aspect of the present invention;

FIG. 4 is a sectional view of the removable build box of FIG. 3;

FIG. 5 is a top perspective view of a feed box of the rapid build box feed chamber filling and storage unit of FIG. 2;

FIG. 6 is a bottom perspective view of a feed box of the rapid build box feed chamber filling and storage unit of FIG. 2;

FIG. 7 is a perspective view of one piston engaging latch of the rapid build box feed chamber filling and storage unit of FIG. 2;

FIG. 8 is a perspective view of one latch turning handle of the rapid build box feed chamber filling and storage unit of FIG. 2; and

FIG. 9 is a perspective view of a removable, sealable lid of the rapid build box feed chamber filling and storage unit of FIG. 2.

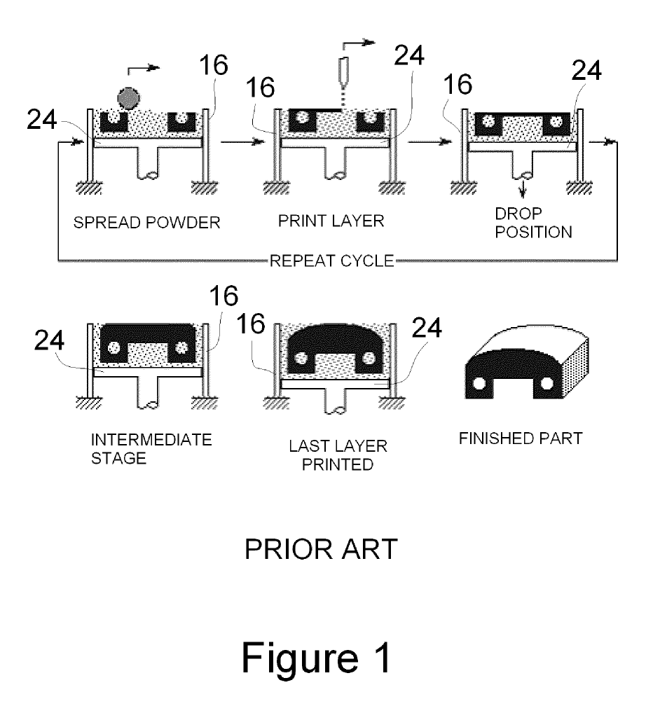

### DESCRIPTION OF THE PREFERRED EMBODIMENTS

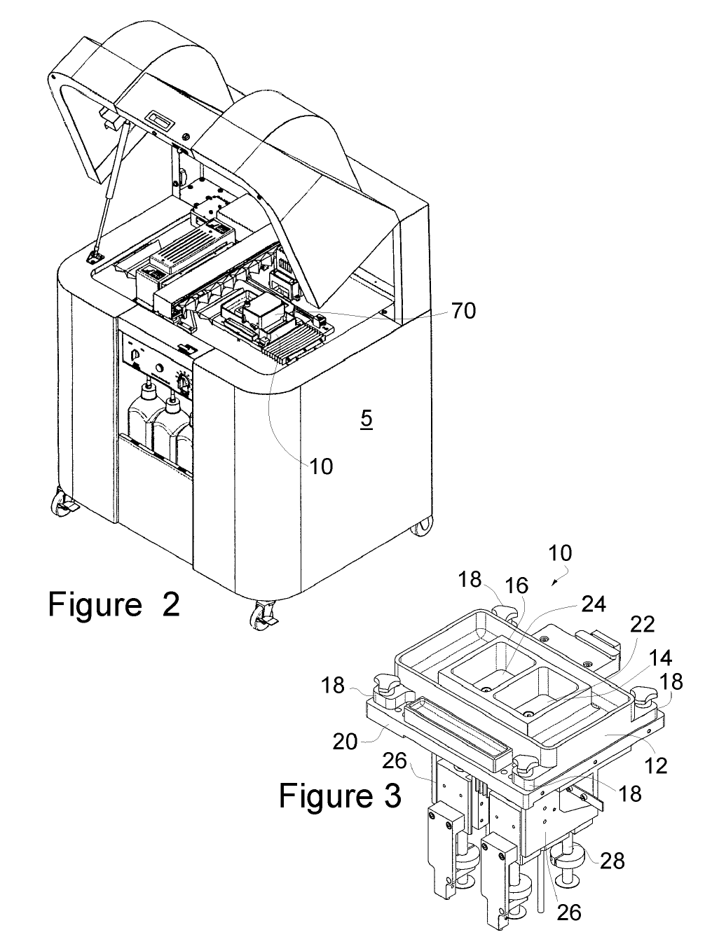

FIG. 2 perspective view of a three dimensional printer 5 with a removable build box 10 according to one aspect of the present invention. The details of the three dimensional printer 5 outside of the removable build box 10 described herein are known in the art and such printers 5 are commercially available from the ExOne Company. These details are not repeated herein.

FIG. 2 also illustrates a rapid feed chamber and storage unit 70 is illustrated in FIG. 2 and this does not form part of this invention other than the illustration that the build box 10 will engage and accommodate other operational fixtures.

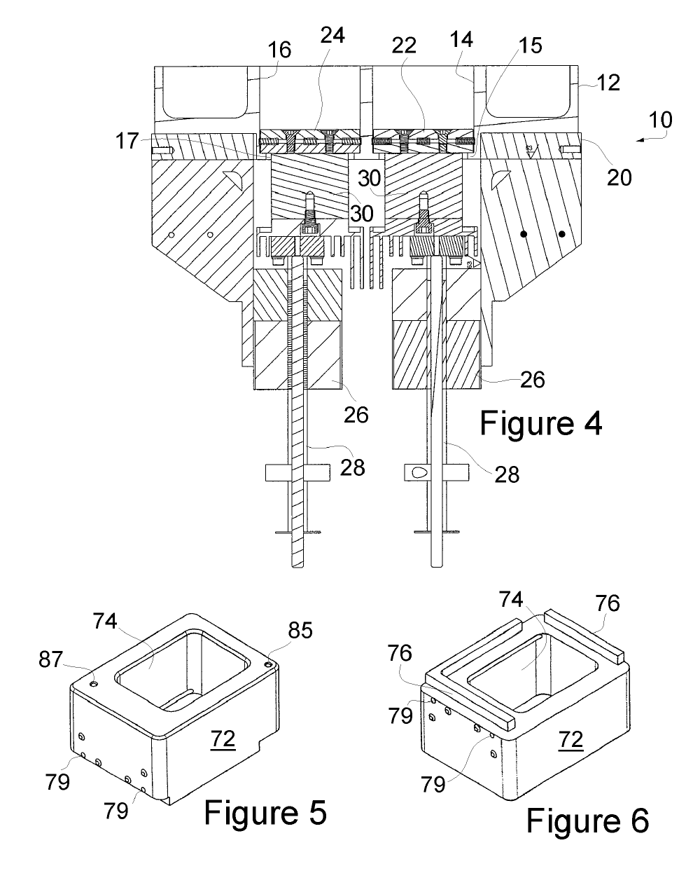

FIGS. 3 and 4 are better illustrations of the removable build box 10 for the three dimensional printer 5. The build box 10 includes a build box tray 12 that defines a build chamber 16 for part assembly and a material feed chamber 14 for supplying powder material to the build chamber 16, the build chamber having lower piston stops 17 and the feed chamber having lower piston stops 15 as shown. The tray 12 may be formed of any convenient material that does not interfere with the material used in the printing operations.

As shown in FIG. 3, hand fastening couplings in the form of thumb screws 18 are on the build box tray 12 for quickly securing the build box tray 12 to a base 20 of the three dimensional printer 5. The base will include taped or threaded holes for receiving the screws 18. The hand fastening couplings may be other hand operated attachments that allow for rapid secure placement, such as sliding or rotting latches.

Referring both to FIGS. 3 and 4 a build chamber piston 24 slidably engaged with the build chamber 16 and is selectively engagable with the piston stops 17 of the build chamber 16 at a lowermost position of the build chamber piston 16. In other words the build chamber piston will rest upon the stops 17 in the lowermost position. The piston 24 includes seals as shown engaging the build chamber 16 to prevent material migrating past the piston 24. The piston 24 further includes a ferrous plate on a lowermost portion thereof.

Analogous to the build chamber piston 24, a feed chamber piston 22 is slidably engaged with the feed chamber 14 and is selectively engagable with the piston stops 15 of the feed chamber 14 at a lowermost position of the feed chamber piston 22. In other words the feed chamber piston 22 will rest upon the stops 15 in the lowermost position. The piston 22 also includes seals as shown engaging the feed chamber 14 to prevent material migrating past the piston 22. The piston 22 further includes a ferrous plate on a lowermost portion thereof.

In order to allow for the removable build box 12 of the present invention a quick connection coupling is provided between the build chamber piston 24 and a build chamber z-axis actuator (that includes a linear actuator 26 and moving rod 28) that is configured to move the build chamber piston 24 when connected thereto; and a quick connection coupling is provided between the feed chamber piston 22 and a feed chamber z-axis actuator (that also includes a linear actuator 26 and moving rod 28) that is configured to move the feed chamber piston 22 when connected thereto. With this construction the build box tray 12 may be easily removed from the three dimensional printer 5.

Each quick connection coupling is formed of an electro-magnet 30 on the end of associated rod 28 and adapted to selectively engage with and disengage from the ferrous plate of the pistons 22 and 24, respectively. Other quick connections are possible, but this type is a non-jarring connection that can be accomplished from above. Appropriate controls for turning the electro-magnets on and off can be provided within easy reach of the operator of the device 5. With the use of electromagnets 30, heat sinks may be provided between the linear actuators and the electromagnets 30 as shown. In addition to heat sinks, a cooling fan can be implemented to alleviate heat build up.

The electromagnetic coupling shown works effectively where non-magnetic materials are used for the printing formation. If magnetic materials are used, then a different coupling connection should be utilized for the quick disconnect, or appropriate shielding between the magnet and the material moved by the pistons should be added, such as spacing the coupling far from the opposed side of the pistons 22 and 24 and modifying the tray 12 to accommodate such an extended coupling (because the tray 12 is a free supporting structure and cannot be supported on elements of the pistons 22 and 24 or the material within the chambers 14 and 16 could be inadvertently advanced out of the chambers while the removable tray is being stored). Consequently the electromagnetic coupling as shown is believed to work exceptionally well for non-magnetic materials such as gold.

As shown both the feed chamber piston 22 and the build chamber piston 24 are configured to move into and out of the feed chamber 14 and the build chamber 16, respectively, through an upper opening thereof. For the build chamber this allows a method of removing the formed part and the supporting material for initial curing. For the feed chamber this allows for rapid material change outs using the same build box.

It should be understood that multiple trays 12 can be utilized with a single printer 5. The trays 12 can have distinct material compositions therein and allow for rapid product type change outs for different runs. In addition to the rapid change out, the tray 12 may be easily removed and stored in a more secure location (e.g. a remote safe) between uses of the printing machine 5. In other words at the end of a work day the operator can quickly remove and secure the build box tray 12 to safe guard the material (e.g. gold).

Another important advantage of the present invention is that where all the components of the build box 12 and pistons 22 and 24 are heat resistant (and care must be taken in the design of the seals for the pistons 22, 24), then the build box 12 of the present invention can be removed and placed directly within the curing oven upon part completion, avoiding a current part transfer operation.

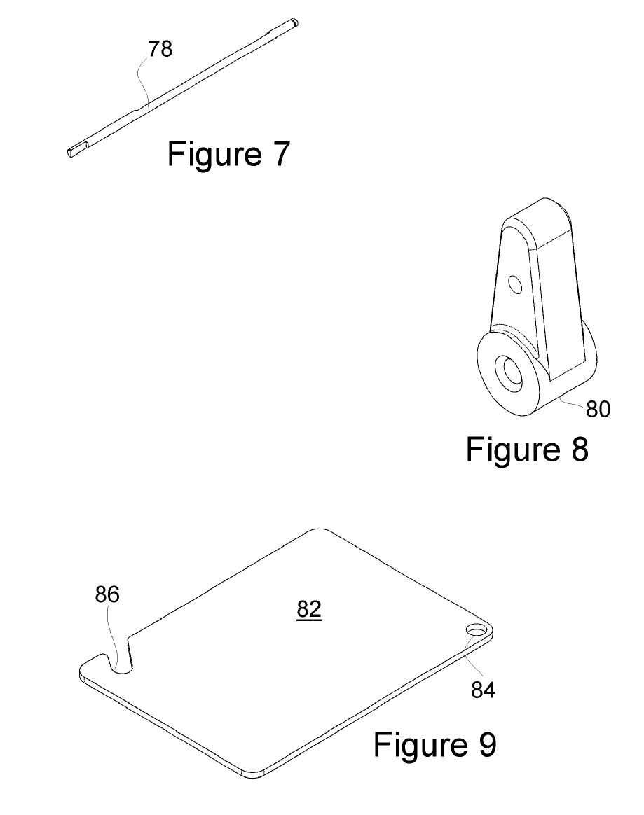

FIG. 2 and FIGS. 5-9 illustrate the rapid feed chamber filling and storage unit 70 according to the present invention. The rapid build box feed chamber filling and storage unit 70 is for supplying material to and storing material from the feed chamber 14 of a build box 12 of a three dimensional printer 5. Although the build box 12 may be removable, the unit 70 also works with non-removable build boxes having feed and build chambers, such as those sold by ExOne Company. In fact the utility of the unit 70 is likely best utilized for non-removable build boxes as the unit 70 allows for rapid filling and for storage of such feed chambers. A removable build box 10 duplicates some of the advantages of the unit 70. Unit 70 allows for an easy method of filling the feed box and removing material there from to assist in material changes. Further, at the end of a shift the material in the feed box may be removed and stored in a secure location. Further the unit 70 is configured to align with the build chamber, such that the unit 70 can also serve as a green product removal device. Finally as the unit 70 is heat resistant, it may be moved directly to the curing oven when holding green printed articles from the build box (and the associated supporting material).

The unit 70 includes a feed box member 72 defining a storage chamber 74 having an open top and open bottom as shown in FIGS. 5 and 6 respectively. The feed box member 72 includes alignment members 76 for aligning the storage chamber 74 vertically above the feed chamber 14 (or the build chamber 16). The feed box member 72 forms a seal, such as metal to metal seal, with the feed chamber 14 (or the build chamber 16) whereby material within the feed chamber 14 (or the build chamber 16) may be advanced via the feed chamber piston 22 (or piston 24) into the storage chamber 74.

The unit 70 includes a pair of piston engaging latches 78 pivoted to the feed box member 72 through mounting holes 79 and are configured to selectively extend within the storage chamber 74 to selectively engage a feed chamber piston 22 (or piston 24) that is receivable within the storage chamber 74. This engagement is similar to the stops 15 and 17 discussed above in the removable build box 10 except that latches 78 can pivot out of the way to allow the piston 22 (or 24) to move into (and out of) the chamber 74.

An actuator or handle 80 is coupled to each latch 78 through one mounting opening 79 and are for moving the latch 78 between the piston engaging and non-engaging positions.

The unit 70 further includes a lid 82 removeably coupled to the feed box member 72 and configured to selectively cover the top opening of the storage chamber 74. An opening 84 allows a threaded attachment to tapped hole 85 forming a pivot for the lid 82 while a notch 86 is configured to be received within a threaded locking post received in tapped hole 87. Other lid configurations are possible. This configuration allows for a tool free removal of the lid where it is not needed, such as when using the unit on the build chamber side for curing.

It should be understood that multiple units 70 can be utilized with a single printer 5. The units 70 can have distinct material compositions therein and allow for rapid product type change outs for different runs. It should be appreciated that the storage chamber 74 is configured to gravity feed material and an associated feed chamber piston 22 to the feed chamber through a release of piston engaging latches 78 when the unit is vertically aligned over the feed chamber and it contains a supply of material over a piston 22. In addition to the rapid material change out, the units 70 may be used such that material within the feed chamber may be easily removed and stored in a more secure location (e.g. a remote safe) between uses of the printing machine 5. In other words at the end of a work day the operator can quickly remove and secure the feed chamber of the build box tray to safe guard the material (e.g. gold). In addition the unit 70 operates as an efficient build chamber green product transfer tool for initial curing. The units 70 are also compatible to existing printer 5 designs.

Although the present invention has been described with particularity herein, the scope of the present invention is not limited to the specific embodiment disclosed. It will be apparent to those of ordinary skill in the art that various modifications may be made to the present invention without departing from the spirit and scope thereof.

What is claimed is:

1. A removable build box for a three dimensional printer comprising:
a build box tray defining a build chamber for part assembly, with the build chamber having lower piston stops;
a build chamber piston slidably engaged with the build chamber and selectively engagable with the piston stops of the build chamber at a lowermost position of the piston; and
a quick connection coupling between the build chamber piston and a build chamber z-axis actuator configured to move the build chamber piston when connected thereto, whereby the build box tray may be easily removed from the three dimensional printer.

2. The removable build box for a three dimensional printer according to claim 1 wherein the quick connection coupling between the build chamber piston and a build chamber z-axis actuator includes a magnetic connection between the build chamber z-axis actuator and the build chamber piston.

3. The removable build box for a three dimensional printer according to claim 2 wherein the magnetic connection includes an electromagnet.

4. The removable build box for a three dimensional printer according to claim 1 further including hand fastening couplings on the build box tray for securing the build box tray to the three dimensional printer.

5. The removable build box for a three dimensional printer according to claim 1 wherein the build chamber piston includes a seal engaging the build chamber.

6. The removable build box for a three dimensional printer according to claim 1 wherein the build chamber piston is configured to move into and out of the build chamber through an upper opening thereof.

7. The removable build box for a three dimensional printer according to claim 1 wherein the tray defines a material feed chamber for supplying powder material to the build chamber.

8. A removable build box for a three dimensional printer comprising:
a build box tray defining a material feed chamber for supplying powder material to a build chamber, the feed chamber having lower piston stops;
a feed chamber piston slidably engaged with the feed chamber and selectively engagable with the piston stops of the feed chamber at a lowermost position of the piston; and
a quick connection coupling between the feed chamber piston and a feed chamber z-axis actuator configured to move the feed chamber piston when connected thereto, whereby the build box tray may be easily removed from the three dimensional printer.

9. The removable build box for a three dimensional printer according to claim 8 wherein the quick connection coupling between the feed chamber piston and a feed chamber z-axis actuator includes a magnetic connection between the feed chamber z-axis actuator and the feed chamber piston.

10. The removable build box for a three dimensional printer according to claim 9 wherein the magnetic connection includes an electromagnet.

11. The removable build box for a three dimensional printer according to claim 8 further including hand fastening couplings on the build box tray for securing the build box tray to the three dimensional printer.

12. The removable build box for a three dimensional printer according to claim 8 wherein the feed chamber piston includes a seal engaging the feed chamber.

13. The removable build box for a three dimensional printer according to claim 8 wherein the feed chamber piston is configured to move into and out of the feed chamber through an upper opening thereof.

14. The removable build box for a three dimensional printer according to claim 8 wherein the tray defines a build chamber adjacent to the feed chamber.

15. A removable build box for a three dimensional printer comprising:
a build box tray defining a build chamber for part assembly and a material feed chamber for supplying powder material to the build chamber, the build chamber having lower piston stops and the feed chamber having lower piston stops;
a build chamber piston slidably engaged with the build chamber and selectively engagable with the piston stops of the build chamber at a lowermost position of the build chamber piston;
a feed chamber piston slidably engaged with the feed chamber and selectively engagable with the piston stops of the feed chamber at a lowermost position of the feed chamber piston;
a quick connection coupling between the build chamber piston and a build chamber z-axis actuator configured to move the build chamber piston when connected thereto; and
a quick connection coupling between the feed chamber piston and a feed chamber z-axis actuator configured to move the feed chamber piston when connected thereto, whereby the build box tray may be easily removed from the three dimensional printer.

16. The removable build box for a three dimensional printer according to claim 15 wherein the quick connections coupling between the feed chamber piston and the feed chamber z-axis actuator and between the build chamber piston and the build chamber z-axis actuator includes a magnetic connection.

17. The removable build box for a three dimensional printer according to claim 16 wherein each magnetic connection includes an electromagnet.

18. The removable build box for a three dimensional printer according to claim 15 further including hand fastening couplings on the build box tray for securing the build box tray to the three dimensional printer.

19. The removable build box for a three dimensional printer according to claim 15 wherein the feed chamber piston includes a seal engaging the feed box chamber and wherein the build chamber piston includes a seal engaging the build chamber.

20. The removable build box for a three dimensional printer according to claim 15 wherein the feed chamber piston is configured to move into and out of the feed chamber through an upper opening thereof, and wherein the build chamber piston is configured to move into and out of the build chamber through an upper opening thereof.
